(19) United States
(12) Patent Application Publication
(10) Pub. No.: US 2005/0134465 A1
(43) Pub. Date: Jun. 23, 2005

(54) Hand cleansing device with monitoring capability

(76) Inventors: Johnathan W. Rice, Riviera Beach, FL (US); Yordan Taneff, Lantana, FL (US)

Correspondence Address: AKERMAN SENTERFITT, P.O. BOX 3188, WEST PALM BEACH, FL, 33402-3188, US

(21) Appl. No.: 11/003,241

(22) Filed: Dec. 3, 2004

Related U.S. Application Data
(60) Provisional application No. 60/528,654, filed on Dec. 6, 2003.

(51) Int. Cl. G08B 23/00

(52) U.S. Cl. 340/573.1; 222/23

(57) ABSTRACT

A hand cleansing device allowing the management of any establishment as well as governmental authorities to monitor individuals for proper use of hygiene.

### CROSS REFERENCE TO RELATED APPLICATIONS

This application claims priority to U.S. Provisional Patent Application No. 60/528,654, filed Dec. 6, 2003.

### FEDERALLY SPONSORED RESEARCH

None

### SEQUENCE LISTING

None

### BACKGROUND OF THE INVENTION—FIELD OF INVENTION

This invention is in the field of health care and is related to maintaining proper hygiene at any work environment.

### BACKGROUND OF THE INVENTION

Both hand washing and monitoring person's performance at different levels of their work are well known activities in prior art. The combination of the activity of hand washing and monitoring said activity, however, has never been mentioned in prior art. Extensive research by computer at the PTO's Patent Server: http://www.uspto.gov/patft/index.html and Delphion's Patent Server: http://www.delphion.com for patents issued since 1971 and in the Patent and Trademark Depository Library in Ft. Lauderdale, Fla., did not uncover any reference with regard to said combination, i.e. others have failed to come up with it. Said combination does solve long but unsolved need—the need to minimize the spread of infection to individuals and the general public alike. Said combination does produce “new and unexpected results”—100% compliance with proper hand washing at the workplace, compared to 30% or less at present, when left up to person's conscientiousness. That means said combination does achieve results greater than the sum of its parts.

### BACKGROUND OF INVENTION—OBJECTS AND ADVANTAGES

The object of the present invention is to have individuals of any establishment use proper hygiene at their place of employment. The advantage of the present invention is a quantitative improvement in preventing the spread of disease to individuals and the general population. Prior to the present invention using proper hygiene at the work place was left up to the conscientiousness of each individual. The present invention will give the management of said establishments the tools to supervise that very important part of their person's activity.

One notable example, and very important use of the present invention, will be monitoring of individuals proper hand washing after the use of rest room facilities. Almost exclusively Hepatitis A is being spread through ingesting food or drinks handled by a person whose hands are contaminated by their own feces. So, individuals in the food service industry, who either do not wash or improperly wash their hands after using rest room facilities, are the main agents of transfer of that and other types of infections to the general population. According to Center for Disease Control, “Hand Washing is the Single Most Important Means of Preventing the Spread of Infection. Nationally, it is estimated that food borne illness kills 5,000 people a year and 5 million more become ill. Washing hands correctly will greatly reduce chances of spreading germs and may reduce food borne illnesses, which add to health care costs in excess of $4 billion in the U.S.” In the last month alone there was an outbreak of Hepatitis A that killed 3 people and sickened 600. All of this could have been prevented by having the infected person wash his/her hands well. Information on the subject matter from different governmental sources, food, health care, industries, etc., are too numerous to present in a patent application and could be obtained on the Internet or in a library.

One of the main advantages of the present invention is that it provides the ability of both management of any establishment and overseeing governmental authorities to monitor person's proper hygiene at work remotely just by checking the data entered into a computer data base. That will improve the monitoring capability of a company management and government individuals alike, both quantitatively and qualitatively. Also, another major improvement of the health of the general population could be achieved if and when the use of the present invention becomes codified nationwide in the United States and abroad.

### SUMMARY

The present invention provides the management of any establishment with the ability to monitor the use of proper hygiene by their individuals at work. Up to now the use of proper hygiene at the work place was left mostly up to the conscientiousness of the individual and the connection between the activity of proper hand washing and monitoring said activity was never made. With the present invention in place at any establishment where proper hygiene is required and/or considered important, compliance with proper hygiene could be brought up to 100% or very close to it. As a result, the transfer of infectious disease to the public in general will be greatly reduced and the expense of treating such incidents of unnecessarily transferred infectious disease minimized. Still further objects and advantages of the present invention will become apparent from a study of the following description and accompanying drawings.

### DRAWINGS—FIGURES

FIG. 1 is a perspective view of the combination of embodiments 3pc and 9pm looking from left, bottom, front side with cover.

FIG. 2 is a perspective view of the combination of embodiments 3pc and 9pm looking from left, bottom, front side without cover.

FIG. 3 is a perspective view of the combination of embodiments 3pc and 9pm looking from top, right, front side without cover.

FIG. 4 is a plan view of the electronic components of the combination of embodiments 3pc and 9pm.

FIG. 5 is a perspective view of embodiment 14com, a combination of embodiments 1pc and 6pm, looking from bottom left side up.

FIG. 6 is a perspective view of embodiment 20com, a combination of embodiments 2pc, 15pr and 7pm, looking from top left side down.

### DRAWINGS—REFERENCE NUMERALS

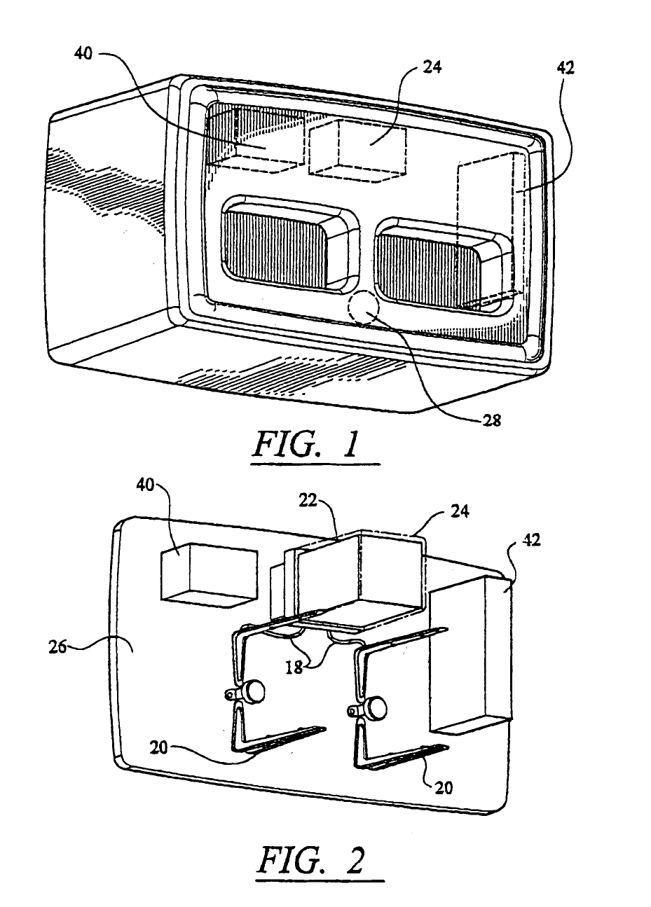

Reference numerals for FIGS. 1,2,3 and 4:
10—cover
12—battery
14—pump
16—spray nozzle, typical 8 places
18—tubing
20—bracket, typical 4 places
24—waterproof cover
26—back cover
28—motion detector
30—strobe light
32—time delay board
34—relay# 1
36—relay# 2
38—momentary switch, typical 2 places
40—electronic unit
42—tank

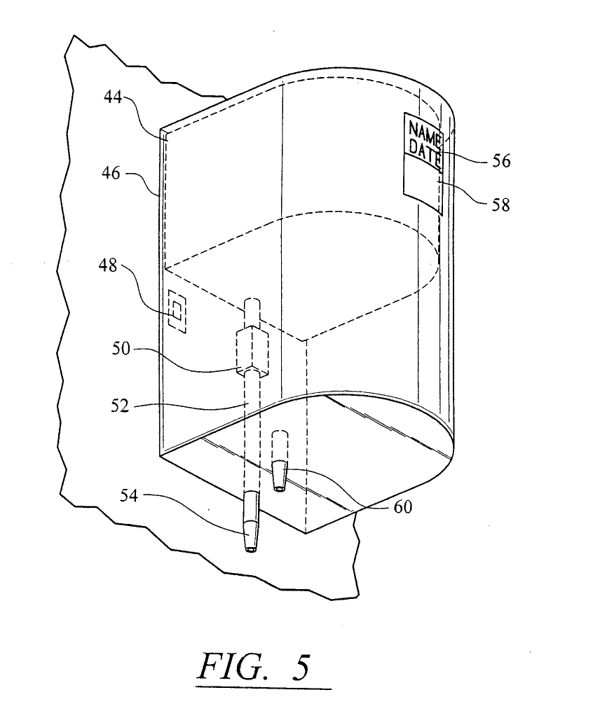

Reference numerals for FIG. 5:

44—tank
46—cleaning substance dispenser
48—power source
50—pump
52—tubing
54—nozzle
56—LCD screen
58—electronic unit
60—sensor and motion detector in one

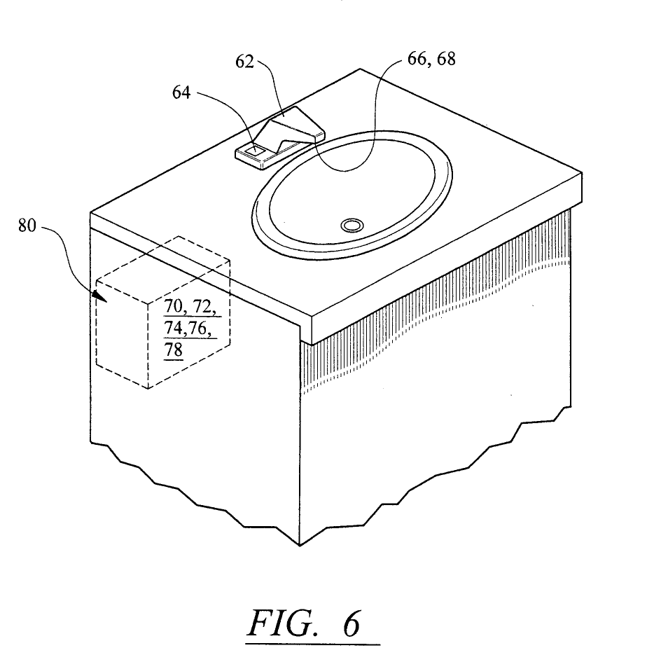

Reference numerals for FIG. 6:
62—faucet
64—LCD screen
72—electronic unit
74—tank
66—sensor
68—outlet for cleaning substance
70—power source
76—pump
78—electric valve
80—box

### DETAILED DESCRIPTION

Notes:

1. In all embodiments the two momentary switches (38) could be replaced by one or two sensors activated by motion, heat, microwaves, or any other means.
2. As set forth in the application, the present invention provides for two separate and distinctive parts of the present invention
   a. Cleaning substance dispenser
   b. Monitoring unit

Due to interchangeability between many of the embodiments for cleaning substance dispensers and for monitoring units, the total number of embodiments for the present invention will be greater than the sum of embodiments for cleaning substance dispensers and monitoring units.
3. As further set forth in the application, in addition to the cleaning substance dispenser and the monitoring unit, in alternative embodiments, other separate and distinctive parts of the invention may also be included:
a. Equivalent to 2.a. —cleaning substance dispenser.
b. Equivalent to 2.b. —monitoring unit.
c. Removal of cleaning substance off of person's hands.

Due to interchangeability between many of the embodiments for cleaning substance dispensers, monitoring units, and removal of cleaning substance units the total number of embodiments for the present invention will be greater than the sum of the embodiments for cleaning substance dispensers, monitoring units, and removal of cleaning substance units. The same embodiments apply to parts 3.a. and 3.b. as to parts 2.a. and 12.b. above.
4. For the present invention, and to ease understanding of some of the different embodiments encompassed by the present invention, a numerical order of embodiments is provided for those embodiments including a cleaning substance dispenser and a monitoring unit, wherein:
   a. Various cleaning substance dispenser embodiments are numbered:

1pc, 2pc, 3pc, 4pc, 5pc
b. Various monitoring unit embodiments are numbered: 6pm, 7pm, 8pm, 9pm
c. Alternative monitoring unit embodiments are numbered; 10am, 11am, 12am, 13am
d. Even though as mentioned in item 2. above, there are many combinations of embodiments of cleaning substance dispensers and monitoring units, following is just one of them: 14com—combination between 1pc and 6pm
5. Likewise, for those embodiments including a cleaning substance dispenser, a monitoring unit, and a removal of cleaning substance means, to ease understanding of some of the different embodiments encompassed by the present invention, a numerical order of embodiments is provided for these embodiments.
   a. Various cleaning substance dispenser embodiments are the same as previously discussed, namely:

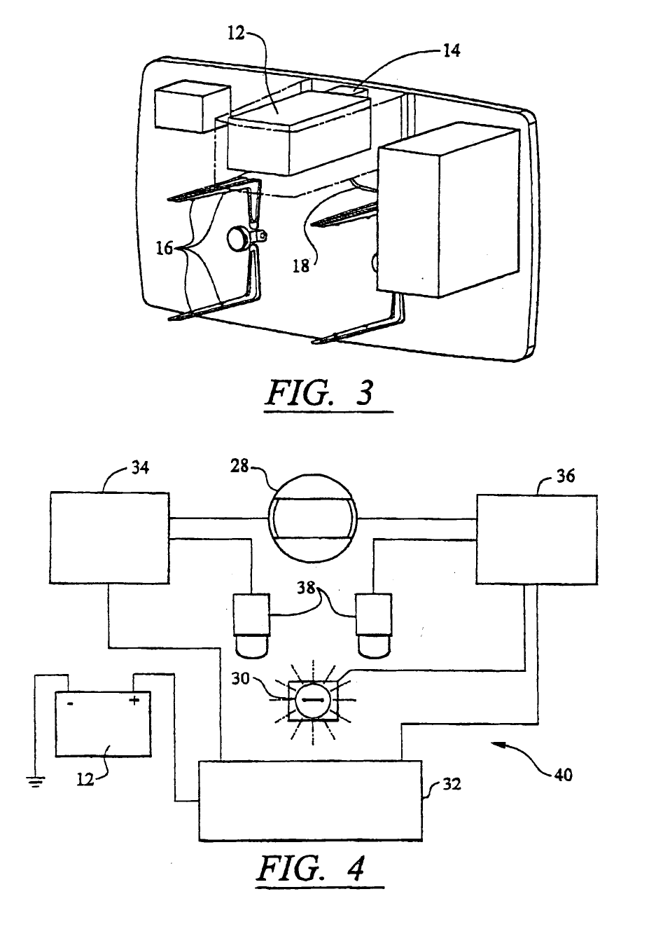

1pc, 2pc, 3pc, 4pc, 5pc
b. Various monitoring unit embodiments are the same as previously discussed, namely:
   6pm, 7pm, 8pm, 9pm
   c. Alternative monitoring unit embodiments are the same as previously discussed, namely:
      10am, 11am, 12am, 13am
   d. Various removal of cleaning substance embodiments are numbered:
      15pr, 16pr, 17pr, 18pr
   e. Alternative removal of cleaning substance embodiments are numbered:
      19ar
   f. Even though as mentioned in item 3. above there are many combinations of embodiments of cleaning substance dispensers, monitoring units, and removal of cleaning substance, following is just one of them:
      20com—combination of 2pc, 15pr and 7pm
         Embodiments of the Present Invention
1pc. One embodiment of a cleaning substance dispenser (see FIG. 5). This embodiment includes a cover that looks like a cover of a regular soap dispenser found in most restrooms with provisions for installation of a battery (48), electronic monitoring unit (58), cleaning substance tank (44), pump (50), nozzle (54), sensor (60) activated by motion, heat, or any other means, and motion detector (60) activated by motion, heat, or any other means. In the case of a restroom, this embodiment could be mounted just like a regular soap dispenser on a wall next to a sink.
2pc. An alternative embodiment of a cleaning substance dispenser (see FIG. 6). Same as 1pc above except that it lacks the motion detector and the cover is a box that could be installed in any inconspicuous location near the location of the cleaning substance dispensation. The sensor (60) performs the function of a motion detector as well.
3pc. Yet another embodiment of a cleaning substance dispenser, FIGS. 1, 2, 3 and 4, includes battery (12), pump (14), eight spray nozzles (16), shown on FIG. 3, tubing (18), four brackets (20), waterproof cover (24), back cover (26) and tank (42), shown on FIG. 2 and two momentary switches (38), shown on FIGS. 2 and 4.
4pc. Still another embodiment of a cleaning substance dispenser. This embodiment includes a pressurized aerosol type container, spray nozzle(s) and two buttons.
5pc. Yet another embodiment of a cleaning substance dispenser. This embodiment includes a cleaning substance container and one or two manually operated hand pumps, activated by pushing two buttons.
   Embodiments for Monitoring Units
6pm. One embodiment of a monitoring unit (see FIG. 5). This embodiment uses Bluetooth, or Zigbee, or Wireless USB, or similar technology incorporated in cellular telephones in Europe. Customers using said technology may buy goods and be billed automatically through their telephone bills. For the purpose of the present invention, said technology will include a master unit located centrally in the area that is being monitored and as many as needed slave units which are going to be used as person's tags. Also, for downloading the data from the master unit into a computer data base, an interface will be used. The interface will be either hardwired or wireless for real time transfer or a transfer unit for periodical transfer. An LCD screen (56), a motion detector (60), activated by motion, heat, or any other means, and a sensor (60), activated by motion, heat, or any other means are part of this unit as well.
7pm. (see FIG. 6) Except for the ability to control an electric valve (78) and the use of the sensor (60) to perform the finctions of the motion detector as well, this embodiment is substantially similar to embodiment 6pm above. The electric valve (78) could have either one mode of operation (normal flow) of two modes of operation (trickle flow and normal flow).
8pm. Except for the use of passive tag and reader technology, this embodiment is substantially similar to either 6pm or 7pm, as needed. The identification number of a passive tag could be read by the reader without the need to power the tag with a battery.
9pm. Yet another embodiment of a monitoring unit—FIGS. 1, 2, 3, 4—includes a battery (12), shown in FIGS. 3 and 4, a motion detector (28), a strobe light (30), time delay board (32), and two momentary switches (38), shown on FIG. 4.

Alternative embodiments for monitoring units for the present invention include, but are not limited to,
10am. One alternative embodiment of a monitoring unit includes a camera at the entrance of any room to be monitored, including a restroom, activated by the opening of the door and a camera located at the hand cleansing unit, activated by pushing the two momentary switches (38), shown on FIG. 2. Both cameras may be with limited view so as to protect the privacy of other people in the room and capable of taking facial and/or tag number shots. Both cameras may show the date and time the snapshot was taken and provide the capability of having the data downloaded into a computer data base.
11am. Yet another alternative embodiment of a monitoring unit includes a camera at the entrance of any room to be monitored, including a restroom, activated by the opening of the door and the two momentary switches (38), shown on FIG. 2. The camera may be capable of taking facial and/or tag number shots. Also it may show the time and date the snapshot was taken and provide the capability of having the data downloaded into a computer data base.
12am. Still another alternative embodiment of a monitoring unit includes keychain units, or tags, issued to each individual and master units located at any station management would like to monitor their individuals. Said technology is available through Datex Corporation in Clearwater, Fla. and others.
13am. Yet another alternative embodiment of a monitoring unit, FIGS. 1,2,3,4 is an improvement of monitoring unit 4pm including a battery (12), shown on FIGS. 3 and 4, a motion detector (28), a strobe light (30), a time delay board (32), two relays or switches (34) and (36) and two momentary switches (38), shown on FIG.4. There is also a switch at the door, remotely controlled by the two momentary switches (38) and a sound alarm.

Select embodiments for those embodiments that feature the removal of cleaning substance off a person's hands.
15pr. One embodiment of a removal of cleaning substance unit (see FIG. 6). This embodiment includes a sink and a faucet (62) with an electric valve (78) electronically controlled for trickle or normal flow, with an outlet for cleaning substance dispensation (68), place for a sensor (66), and an LCD screen (64).
16pr. An alternative embodiment for a removal of cleaning substance unit. Substantially similar to embodiment 15pr above without the provision for trickle flow, and the LCD screen (for use in work environment or by the general public).
17pr: Still another alternative embodiment for a removal of cleaning substance off person's hands includes any sink with a foot operated faucet.
18pr: Yet another alternative embodiment for a removal of cleaning substance off person's hands. This embodiment is a modification of embodiment 15pr. It includes any sink, the two momentary switches (38), shown on FIGS. 2 and 4, and a foot operated faucet with a time delay mechanism.

Alternative embodiment for removal of cleaning substance off a person's hands
19ar. An additional embodiment for the removal of cleaning substance off a person's hands includes any sink with a faucet. Said faucet could be outfitted with a time delay mechanism after pushing the two momentary switches (38), shown on FIGS. 2 and 4.
   Operation

Note: In all embodiments the two momentary switches or buttons (38) (or sensor[s]) act as liaison between the cleaning substance dispenser, the electronic unit, and in the case of an embodiment including the removal of cleaning substance unit, the cleaning substance unit as well, since they activate all three of them.
1pc. One embodiment of a cleaning substance dispensation unit (see FIG. 5). This embodiment functions as follows: The battery (48) powers the sensor (60) and the pump (50). When the sensor (60) is activated, it immediately activates the pump (50) for a few seconds, and as a consequence, the pump (50) sucks cleaning substance from the tank (44) and discharges it through the nozzle (54) onto the person's hand.
2pc. Another embodiment of a cleaning substance dispensation unit (see FIG. 6). The cleaning substance dispensation portion of this embodiment functions exactly as the one for 1pc above.
3pc. Yet another embodiment of a cleaning substance dispenser. When the two momentary switches (38) are pushed simultaneously, pump (14), powered by battery (12), is activated, sucks cleaning substance from tank (42), sends said substance, under pressure, through tubing (18) to eight spray nozzles (16) and sprays said cleaning substance onto person's hands. Said two momentary switches (38) may be pushed together in order to ensure that both of person's hands have cleaning substance applied to them. Back cover (26) and four brackets (20) are used to mount all the components listed above. There is a fully operational prototype of this embodiment together with embodiment 4pm. Pictures of the prototype were enclosed with the disclosure document no. 541852 stamped on Nov. 13, 2003.
4pc. Still another embodiment of a cleaning substance dispenser. This embodiment is a variation of embodiment 3pc, where pump (14) and tank (42) were replaced by a pressurized aerosol type container which is being activated by the two buttons (38), shown on FIG. 2.
5pc. Yet another embodiment of a cleaning substance dispenser. This embodiment, again, is a variation of embodiment 3pc, where, pump (14), was replaced by one or two hand operated pumps activated by pushing the two momentary switches (38) shown on FIG. 2. All cleaning substance dispensers embodiments may perform well without major disadvantages.
6pm. One embodiment of a monitoring unit (see FIG. 5). In the case of Bluetooth, or Zigbee, or Wireless USB, or similar technology the master unit will be centrally located in the area that is being monitored. As soon as a slave unit, or individual tag, moves within the area of coverage of the master unit, the master unit will pick the tag number, the time and date, and as soon as the individual moves out of the area of the coverage of the master unit, the master unit will register the tag number, the time and date at which the individual moved out of the area. During the time the individual is in the coverage area of the master unit, the individual should activate the sensor (60), which in turn will activate the pump (50), dispense cleaning substance on person's hand, activate the motion detector (60), and register person's ID number with time and date only after individual has briskly rubbed the cleaning substance onto his/her hands for 20 seconds as required by code. The motion detector (60) will ensure that the code provision was followed. One way of detecting motion for 20 seconds is by having the motion detector (60) on for 2 seconds and off for 1 second. After detecting motion for 7 cycles of 3 seconds each, the motion detector (60) will send the information to the master unit. Only after that the individual will have been considered as having complied with all the requirements. Otherwise, after individual exits the monitored area, a default will be displayed on the LCD screen (56) with name, tag number, time and date, and transferred real time or periodically to a computer databank.

The advantages of this embodiment are:
e. Ability to monitor numerous individuals at the same time.
f. Allows management and government individuals, charged with overseeing a particular industry, to monitor the activity of hand washing remotely.
g. Brings 100% compliance with hand washing.
7pm. Yet another embodiment of a monitoring unit (see FIG. 6). Except for the control of the electric valve (78) and the use of the sensor (66) to perform the functions of the motion detector as well the operation of this embodiment is substantially similar to the operation of embodiment 6pm above. The electric valve (78) is being used for removal of cleaning substance off of person's hands. It has two modes of operation—trickle flow and normal flow mode of operation. The trickle mode of operation will be activated 3 seconds after activating the sensor in order to allow dispensation of undiluted cleaning substance on person's hand and will last until the sensor has completed 7 cycles of 3 seconds each during which motion was detected. At the end of said 7 cycles the flow mode of the electric valve (78) will change to normal flow in order to allow the individual to remove the cleaning substance off of his/her hands. The electric valve (78) will turn off and the sensor (66) will rearm for the next person only after the sensor stops detecting motion for a period of 5 seconds. All other functions are substantially similar to the functions of embodiment 6pm above.
8pm. Still another embodiment of a monitoring unit. This embodiment uses similar but somewhat different technology than the previous two. It employs passive tags and readers. The tag ID numbers with time and date are picked up by a reader at the entrance door of the monitored room and are relayed through the electrical wiring of the building (power line carrier system) to the wall unit where the cleaning substance dispenser, sensor, and motion detector are located. If the person does not activate the sensor on the wall unit within 30 minutes of entering the room, have his/her ID number picked up with time and date by the reader on the wall, and then follow the procedure outlined in item 6pm above, a default will be displayed on the LCD screen and recorded for transfer into a computer databank.
9pm. Yet another embodiment of a monitoring unit. There is a fully operational prototype of this embodiment together with embodiment 3pc. Normally the motion detector (28) is armed and the strobe light (30) is off. As soon as the motion detector (28) picks up some movement the strobe light (30) turns on and stays on until the individual pushes the two momentary switches (38) simultaneously. The two momentary switches (38) may be pushed simultaneously in order to dispense the cleaning substance, turn the strobe light (30) off and turn the motion detector (28) off for a preset period of time and then rearm it. In a case of a restroom, through the use of time delay board (32), the preset period of time should be long enough to allow the individual to wash his/her hands, remove the cleaning substance if required, and exit the rest room. After the individual has left the restroom, a lit strobe light (30) will indicate a default Preferably, the strobe light (30) may be installed at the door of the restroom, or any other convenient location where anyone could see that the restroom is either occupied or that someone has defaulted. The advantages of this embodiment are:
a. Simplicity
b. Low cost
c. Puts enough pressure on individuals to bring compliance with hand washing almost to 100%.

The disadvantage of this embodiment is:
d. If, in the case of a rest room, more than one individual is using the rest room at a time, there is some room for non-compliance. Still, it will take an unconscientious individual to do so.
10am. Still another embodiment of a monitoring unit. In the case of a rest room, any time an individual enters the rest room a facial and/or tag number snapshot with the time and date will be taken. Before exiting the rest room another facial and/or tag number snapshot with a time and date will be taken at the hand washing device. The snapshot will be triggered by pushing the two momentary buttons (38) which will dispense cleaning substance on person's hands as well.

In a case of an open area, a facial and/or tag number snapshot with time and date, at the hand washing device, after pushing the two buttons (38), will suffice. Person's performance in an open area could be measured as an average number of times over a certain period of time

An interface with a computer will provide the ability to download the data into a computer database.

The advantages of this embodiment are:
h. Ability to monitor numerous individuals at the same time.
i. Allows management and government individuals, charged with overseeing a particular industry, to monitor the activity of hand washing remotely.
j. Brings 100% compliance with hand washing.
11am. Yet another embodiment of a monitoring unit. This is a variation of embodiment 10am. In a case of a rest room a facial and/or tag number snapshot with a time and date will be taken upon the individual entering the room. Said individual may erase the snapshot remotely by pushing the two momentary buttons (38) and at the same time have cleaning substance dispensed on his/her hands, so that he/she may wash them. In this embodiment if there are any pictures left in the camera they would be of individuals who did not wash their hands. The camera may have the capability to have the data downloaded into a computer data base.

The advantages of this embodiment are:
k. Ability to monitor numerous individuals at the same time.
l. Allows management and government individuals, charged with overseeing a particular industry, to monitor the activity of hand washing remotely
m. Brings 100% compliance with hand washing.
12am. Still another embodiment of a monitoring unit. This embodiment will be suitable for monitoring individuals in an open area where performance could be measured as an average number of times over a certain period of time. Individuals will wear an individual issued key chain unit with capability to record the time and date, when inserted into a master unit. The master unit may be made available for insertion only after the individual has washed his/her hands, which could be achieved through fairly simple means. Said key chain unit has the capability to have its stored data downloaded into a computer data base. This embodiment could be adapted for monitoring a person's hygiene at any room, including a rest room.

The advantages of this embodiment are:
n. Ability to monitor numerous individuals at the same time.
o. Allows management and government individuals, charged with overseeing a particular industry, to monitor the activity of hand washing remotely.
p. Brings 100% compliance with hand washing.
13am. Yet another embodiment of a monitoring unit. This embodiment is an improvement of monitoring unit 9pm, whose operation is described above. In addition to what embodiment 9pm may achieve, however, this embodiment has an additional feature, which puts extra pressure on individuals to comply with hand washing. Said feature will sound an audible alarm in case the individual does not push the two momentary buttons (38) and exits. So, in addition to the strobe light remaining lit, the audible alarm will notify everybody in the vicinity that the individual is in default. The activation of said additional feature is achieved by activating the audible alarm through a switch at the door. Said switch at the door is activated remotely if the door is opened before the two momentary switches have been pushed and the individual has washed his/her hands.

In addition to the advantages listed for embodiment 9pm this embodiment eliminates embodiment's 9pm only disadvantage, i.e. room for non-compliance in case more than one individual at a time is using the monitored room.
14com. This embodiment is a beneficial combination of embodiments: 1pc—cleaning substance dispenser, and 6pm—monitoring unit (see FIG. 5). The function of this embodiment is fairly well covered by the description of its components. In case removing of the cleaning substance off of the person's hands is required, the most likely place of installing it would be a wall next to a sink. The adjustable motion detector (60) will make it possible to direct it toward the sink where the person will rub the cleaning substance into his/her hands for 20 seconds. The development and introduction to the market of this embodiment will be a quantum jump over what is available now in prior art. The closest devices known on the market dealing with the subject of proper hand washing are beepers and light prompts to notify the person that he/she has completed the 20 second requirement for rubbing the cleaning substance onto his/her hands and that requirement as well as the requirement to wash one's hands is left entirely up to the conscientiousness of the person.
15pr. This embodiment works in conjunction with embodiments 2pc and 7pm (see FIG. 6). When the sensor (60) is activated by motion, heat, or any other means, it activates in turn the cleaning substance dispensation immediately and the trickle mode of the electric valve (78) with a 3-second delay. After the sensor (66) detects motion for 20 seconds (20 seconds are required by code for briskly rubbing the cleaning substance onto one's hands), the normal flow mode of the electric valve (78) is turned on so that the individual may wash his/her hands. After the sensor (66) stops detecting motion for a period of 7 seconds, the sensor (66) is rearmed for another cycle. One way of detecting 20 seconds' worth of motion during the time the electric valve (78) is in trickle mode could be achieved by having the sensor (66) on for 2 seconds and off for 1 second. After the sensor (66) goes through 7 cycles of detecting motion, the normal flow mode of the electric valve (78) may be turned on. Defaults, if any, will be displayed on the LCD screen (64).
16pr. This embodiment is a simplified version of embodiment 15pr. It works in conjunction with embodiments 1pc and 6pm. When the sensor (a substitute for the two momentary switches [38]) is activated by motion, heat, or any other means, it activates in turn the cleaning substance dispenser immediately and the electric valve with a 3-second delay. After the sensor stops detecting motion for 7 seconds, the electric valve turns off and the sensor is rearmed for another cycle.
17pr. One embodiment removal of cleaning substance unit. Operation of this embodiment is self-explanatory.
18pr. Another embodiment of a removal of cleaning substance unit. By pressing the momentary switches (38) (or activating the sensor), the operation of the foot-operated faucet will be delayed in order to allow the person to rub the cleaning substance onto his/her hands.
19pr. Still another embodiment of a removal of cleaning substance unit. By pressing the momentary switches (or activating the sensor), the operation of the hand-operated faucet will be delayed to allow the person to rub the cleaning substance onto his/her hands.
20com. (see FIG. 6) This embodiment is a beneficial combination of embodiments:
   2pc—cleaning substance unit;
   15pr—removal of cleaning substance unit; and
   7pm—monitoring unit

The function of this embodiment is fairly well covered by the description of its components. It is the most inconspicuous of all embodiments. It will look like a regular faucet, and almost any faucet could be modified for the purpose of using it with this embodiment. All other components will be hidden out of sight. The only disadvantage could be somewhat higher price for parts and installation.

Conclusion, Ramifications and Scope

Accordingly, the reader will see that the present invention is one whose time has come. When it becomes codified nationwide, and possibly abroad, it will reduce tremendously the spread of infectious diseases and the cost associated with it. Said cost, as discussed earlier, is estimated to be $4 billion in the United States.

While a few embodiments have been listed, it is contemplated that the present invention includes alternative embodiments that, depending on the manner in which they were implemented, could be just as good or better. For example:

Video camera installed right above the hand cleansing device with limited view so as to protect the privacy of others in the room, especially if said device is in a rest room.

Use same or similar technology as the one used at toll roads by drivers who do not stop at the toll gates to pay toll and have their code cards read while moving.

Use same or similar technology as the one at department stores for setting off an alarm at the exit door if a customer is taking an item out of the store without having paid for it.

Use of fingerprint identification technology.

In instances where washing hands and forearms is required, this could easily be done with slight modification of the hand cleansing device. In said instance hands could be inserted into cover 10 up to the elbows preferably from the side of the box or from the front.

Also, while the above description contains many specifics, these should not be construed as limitations on the scope of the present invention, but rather as an exemplification of the embodiments described. Many other variations are possible.

Accordingly, the scope of the present invention should be determined not by the embodiments described, but by the appended claims and their legal equivalents

1. A hand cleansing device with monitoring capability comprising:
a. a cleaning substance;
b. a dispenser for applying the cleaning substance to a person's hands in an amount to properly clean the person's hands; and
c. means to monitor whether a person has cleaned their hands using the hand cleansing device.

2. The hand cleansing device of claim 1, wherein the cleaning substance is selected from soap, anti-microbial soap, an antiseptic material, a hand sanitizer material, or a combination thereof.

3. The hand cleansing device of claim 1, wherein the dispenser further includes means for providing power to the device selected from a battery, AC power, or a combination thereof.

4. The hand cleansing device of claim 1, wherein the dispenser dispenses cleaning substance using a dispensing means selected from a nozzle, a pump, an aerosol container, a button, or a combination thereof.

5. The hand cleansing device of claim 1, wherein the means to monitor whether a person has cleaned their hands using the hand cleansing device includes at least one sensor selected from a motion sensor for detecting whether cleaning substance has been dispensed, a heat sensor for detecting whether cleaning substance has been dispensed, a motion detector for detecting whether a person has entered a room having the hand cleansing device, a heat detector for detecting whether a person has entered a room having the hand cleansing device, or a combination thereof.

6. The hand cleansing device of claim 1, wherein the means to monitor whether a person has cleaned their hands using the hand cleansing device further includes a system for tracking whether an individual has used the hand cleansing device.

7. The hand cleansing device of claim 6, wherein the system for tracking whether an individual has used the hand cleansing device includes a wireless transmitter a computer, a liquid crystal display, a motion detector or a combination thereof.

8. The hand cleansing device of claim 1, wherein the means to monitor whether a person has cleaned their hands using the hand cleansing device further includes means for a person to monitor the activation of the hand cleaning device, wherein the means for a person to monitor the activation of the hand cleaning device is selected from a radio frequency identification tag, a radio frequency identification tag reader, a bar code, a bar code reader, or a combination thereof.

9. The hand cleansing device of claim 1, further comprising a timer for timing the length of time a person washes their hands.

10. A hand cleansing device with monitoring capability comprising:
a. a cleaning substance;
b. means for applying the cleaning substance to an person's hands in an amount to properly clean the person's hands;
c. means to remove the cleaning substance off of the person's hands; and
d. means to monitor whether a person has cleaned their hands using the hand cleansing device.

11. The hand cleansing device of claim 10, wherein the means to remove the cleaning substance off of the person's hands comprises a water source.

12. The hand cleansing device of claim 10, wherein the cleaning substance is selected from soap, anti-microbial soap, an antiseptic material, a hand sanitizer material, or a combination thereof.

13. The hand cleansing device of claim 10, wherein the dispenser further includes means for providing power to the device selected from a battery, AC power, or a combination thereof.

14. The hand cleansing device of claim 10, wherein the dispenser dispenses cleaning substance using a dispensing means selected from a nozzle, a pump, an aerosol container, a button, or a combination thereof.

15. The hand cleansing device of claim 10, wherein the means to monitor whether a person has cleaned their hands using the hand cleansing device includes at least one sensor selected from a motion sensor for detecting whether cleaning substance has been dispensed, a heat sensor for detecting whether cleaning substance has been dispensed, a motion detector for detecting whether a person has entered a room having the hand cleansing device, a heat detector for detecting whether a person has entered a room having the hand cleansing device, or a combination thereof.

16. The hand cleansing device of claim 10, wherein the means to monitor whether a person has cleaned their hands using the hand cleansing device further includes a system for tracking whether an individual has used the hand cleansing device.

17. The hand cleansing device of claim 16, wherein the system for tracking whether an individual has used the hand cleansing device includes a wireless transmitter, a liquid crystal display, or a combination thereof.

18. The hand cleansing device of claim 10, wherein the means to monitor whether a person has cleaned their hands using the hand cleansing device further includes means for a person to monitor the activation of the hand cleaning device, wherein the means for a person to monitor the activation of the hand cleaning device is selected from a radio frequency identification tag, a radio frequency identification tag reader, a bar code, a bar code reader, or a combination thereof.

19. The hand cleansing device of claim 10, further comprising a timer for timing the length of time a person washes their hands.
